(19) United States
(12) Patent Application Publication
(10) Pub. No.: US 2017/0347089 A1
(43) Pub. Date: Nov. 30, 2017

(54) COMBINING VR OR AR WITH AUTOSTEREOSCOPIC USAGE IN THE SAME DISPLAY DEVICE

(71) Applicant: Craig PETERSON, North Plains, OR (US)

(72) Inventor: Craig PETERSON, North Plains, OR (US)

(21) Appl. No.: 15/606,994

(22) Filed: May 26, 2017

Related U.S. Application Data
(60) Provisional application No. 62/342,586, filed on May 27, 2016.

(51) Int. Cl. H04N 13/04; H04N 13/00

(52) U.S. Cl. CPC H04N 13/0486; H04N 13/044; H04N 13/0454; H04N 13/0022; H04N 13/0409; H04N 13/0404; H04N 2213/008

(57) ABSTRACT

A system for display three dimensional content on a display.

### CROSS-REFERENCE TO RELATED APPLICATIONS

This application claims the benefit of U.S. Provisional App. No, 62/342,586, filed May 27, 2016.

### TECHNICAL FIELD

The present invention relates generally to a virtual reality system incorporating a mobile computing device.

### BACKGROUND OF THE INVENTION

Two dimensional video content, such as obtained with a video camera having a single aperture, is often either projected onto a display screen for viewing or viewed on a display designed for presenting two dimensional content. Over time, the resolution of displays has tended to increase, from standard television interlaced content resolution (e.g., 480i), to high definition television content (e.g., 1080i), to 4K definition television content (4K UHD), and even to even higher definition television content (e.g., 8K UHD). Such increases in video resolution technology only provide for limited increases in the apparent image quality to the viewer. Accordingly, the viewer is only immersed in the video experience to a limited extent.

To increase the immersive experience of the viewer it is desirable to effectively convert two dimensional image content into three dimensional (3D) image content, including no-glasses 3D content and glasses-based 3D content, which is thereafter displayed on a suitable display for viewing three dimensional image content. The perception of three dimensional content may involve a third dimension of depth, which may be perceived in a form of binocular disparity by the human visual system. Since the left and the right eyes of the viewer are at different positions, each eye perceives a slightly different view of a field of view. The human brain may then reconstruct the depth information from these different views to perceive a three dimensional view. To emulate this phenomenon, a three dimensional display may display two or more slightly different images of each scene in a manner that presents each of the views to a different eye of the viewer. A variety of different display technologies may be used, such as for example, anaglyph three dimensional system, passive-polarized three dimensional display system, active-shutter three dimensional display system, autostereoscopic lenticular no-glasses 3D display system, autostereoscopic parallax-barrier n0-glasses 3D display system, and head mounted stereoscopic display system.

As three dimensional display systems become more readily prevalent the desire for suitable three dimensional content to present on such displays increases. One way to generate three dimensional content is using three dimensional computer generated graphics. Another way to generate three dimensional content is using three dimensional video camera systems. Another technique to generate three dimensional content is using the vast amounts of available two dimensional content and converting the two dimensional content into three dimensional content. While such content may be displayed on a display, and in particular on a mobile display such as a phone, the content should be rendered in a manner most consistent with the manner in which the content is being viewed.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates one embodiment of a display device.

FIG. 2 illustrates another embodiment of a display device.

FIG. 3 illustrates a head mounted display device.

FIG. 4 illustrates a side-by-side view on a display device.

FIG. 5 illustrates a technique for selecting a particular rendering technique.

FIG. 6 illustrates a parallax barrier and a lenticular lens based rendering technique.

FIG. 7 illustrates an application providing side by side content,

### DETAILED DESCRIPTION OF PREFERRED EMBODIMENT

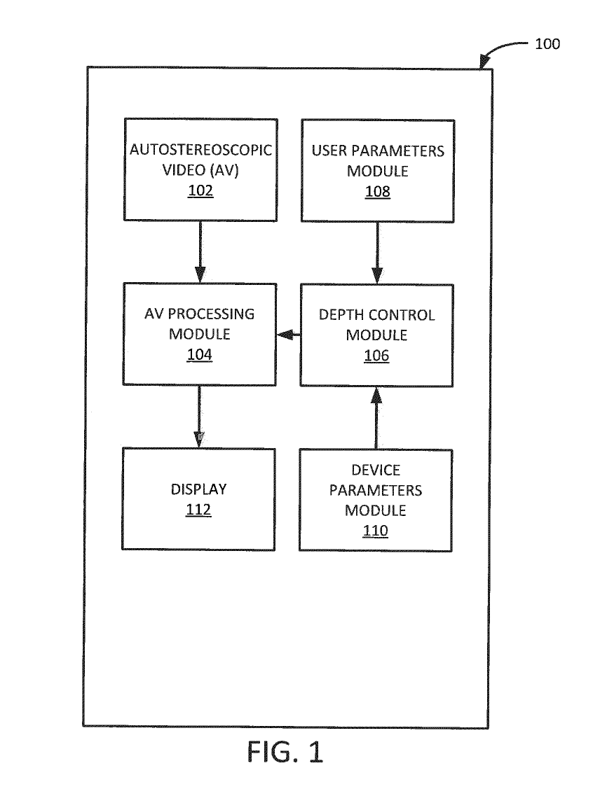

Referring to FIG. 1, an exemplary system 100 is configured for displaying audio-visual content. The system 100 may be a mobile or non-mobile device or a group of devices capable of displaying audio-visual content. For example, the device may be a mobile device such as a cellular mobile phone or smart-phone based on the Android operating system, iOS, Blackberry OS, Palm OS, Symbian OS, etc. For example, the device may be a tablet computer like an iPad, Galaxy Tab, Kindle Fire, Surface, Surface Pro, etc. For example, the device may include a table computer like a laptop computer, a netbook computer, etc. For example, the device may include a stationary device capable of displaying audio-visual content such as a desktop computer with an integrated or separate display, a standalone monitor, and/or television.

The system 100 may display audio-visual content 102 such as content inserted in or coupled to the system 100, such as content stored within the system 100, such as content provided to the system 100 through a wire or wireless communication (e.g., “streaming”). The system 100 may include an AV processing module 104 to process the received content in a manner suitable for being displayed on a display 112. For example, the display may include two images, one for viewing by the left eye of a viewer and another for viewing by the right eye of the viewer. The left eye may be provided multiple different images/views, such as based upon the viewers position, if desired. The right eye maybe provided multiple different images/views, such as based upon the viewers position, if desired. The display 112 may be configured to separate the left and right images so that they are primarily only viewed by the left eye and the right eye, respectively. By way of example, the left and right images may be separated by a parallax barrier lens and/or a lenticular lens. For example, the parallax barrier may interpose many small opaque barriers that act to block the images so that they are only viewed by the intended eye. For example, the lenticular array display may employ many small lenses integrated into the display to focus the images so that they are only viewed by the intended eye. By changing the separation (e.g., the disparity) between the left and right images, the amount of depth perceived by a viewer may be increased, diminished, and/or reversed.

The depth perceived may be automatically determined by the system 100, or automatically determined based upon the content 102, or be a fixed value. Preferably the depth perceived is adjustable by the viewer. A depth control module 106 may receive user parameters from a user parameters module 108 and/or device parameters from a device parameters module 110, and use such parameters to adjust the depth perceived. For example, the user parameters may be entered or adjusted by the viewer. For example, the device parameters may be based upon the characteristics of the device and/or the position of the device in relation to the viewer.

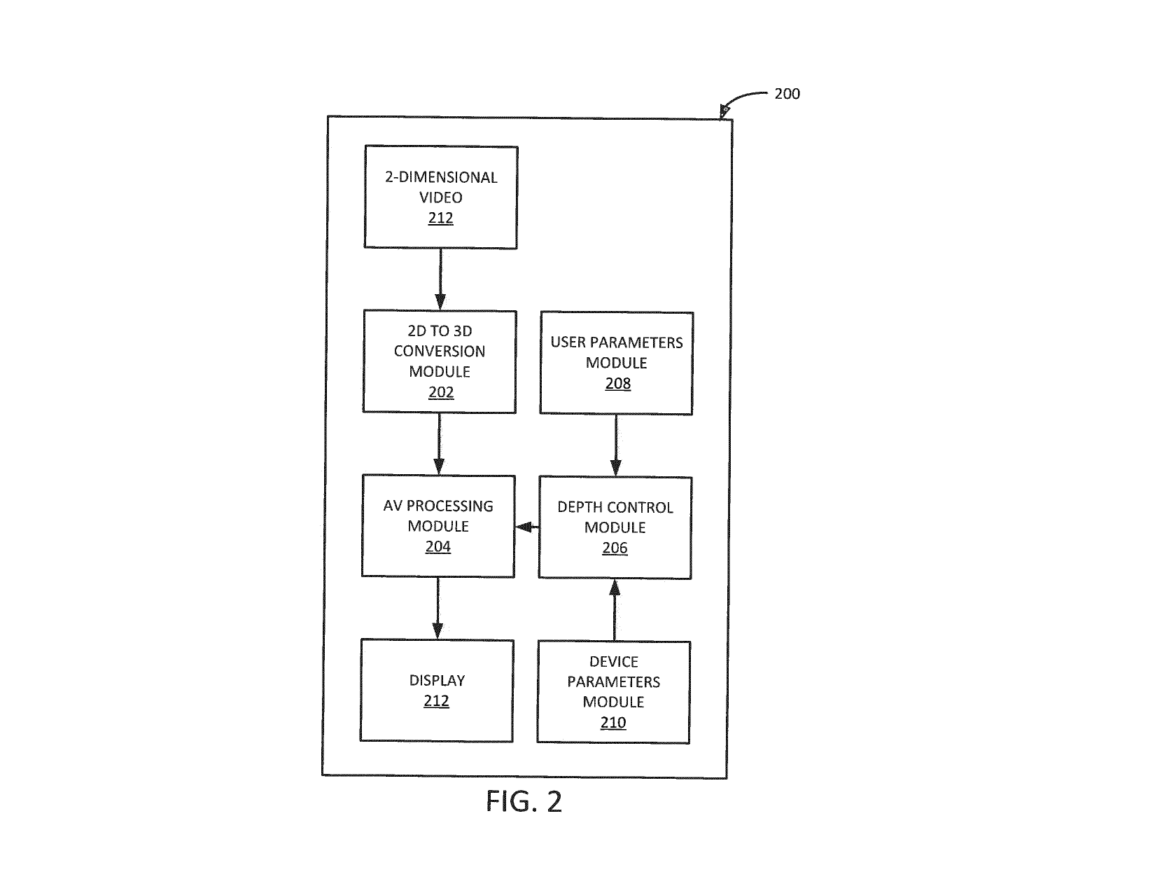

Referring to FIG. 2, an exemplary system 200 is configured for displaying audio-visual content. The system 200 may be a mobile or non-mobile device or a group of devices capable of displaying audio-visual content. For example, the device may be a mobile device such as a cellular handset or smart-phone based on the Android operating system, iOS, Blackberry OS, Palm OS, Symbian OS, etc. For example, the device may be a tablet computer like an iPad, Galaxy Tab, Kindle Fire, Surface, Surface Pro, etc. For example, the device may include a table computer like a laptop computer, a netbook computer, etc. For example, the device may include a stationary device capable of displaying audio-visual content such as a desktop computer with an integrated or separate display, a standalone monitor, and/or television.

The system 200 may display two dimensional audio-visual content 212 such as content inserted in or coupled to the system 200, such as content stored within the system 200, such as content provided to the system 200 through a wire or wireless communication (e.g., “streaming”). The system 200 may convert the two dimensional audio-visual content 212 to three dimensional audio-visual content using a 2D to 3D conversion module 202. The system 200 may include an AV processing module 204 to process the received content in a manner suitable for being displayed on a display 212. For example, the display may include two images, one for viewing by the left eye of a viewer and another for viewing by the right eye of the viewer. The left eye may be provided multiple different images/views, such as based upon the location, if desired. The right eye maybe provided multiple different images/views, such as based upon the location, if desired. The display 212 may be configured to separate the left and right images so that they are primarily only viewed by the left eye and the right eye, respectively. By way of example, the left and right images may be separated by a parallax barrier and/or a lenticular array. For example, the parallax barrier may interpose many small opaque barriers that act to block the images so that they are only viewed by the intended eye. For example, the lenticular array display may employ many small lenses integrated into the display to focus the images so that they are only viewed by the intended eye. By changing the separation (e.g., the disparity) between the left and right images, the amount of depth perceived by a viewer may be increased, diminished, and/or reversed.

The depth perceived may be automatically determined by the system 200, or automatically determined based upon the content 212, or be a fixed value. Preferably the depth perceived is adjustable by the viewer, A depth control module 206 may receive user parameters from a user parameters module 208 and/or device parameters from a device parameters module 210, and use such parameters to adjust the depth perceived. For example, the user parameters may be entered or adjusted by the viewer. For example, the device parameters may be based upon the characteristics of the device and/or the position of the device in relation to the viewer.

In some embodiments, it may be observed that the views that the viewer observes, such as the one or more views for the left eye and the one or more views for the right eye, are spaced across a major portion of the display and preferably across substantially all of the display, With this configuration, the display is especially suitable for the displaying three dimensional content on the display in a manner that is flexible for the viewer to observe. While the resolution does not tend to be exceptionally high depending on the number of views that are presented, it provides a flexible viewing environment since the viewer can hold the phone in their hands while viewing the content.

In some environments, a head mounted display is used to display three dimensional image content, often referred to as a virtual reality and/or augmented reality systems. Often the virtual reality systems envelop a wearer's eyes completely and substitute a “virtual” reality for reality. On example of a virtual reality environment is for a video game involving a player character interacting with a game world. One example of an augmented reality environment is an overlay of semi-transparent and/or transparent items on a display, such as upcoming appointments of a viewer on the screen.

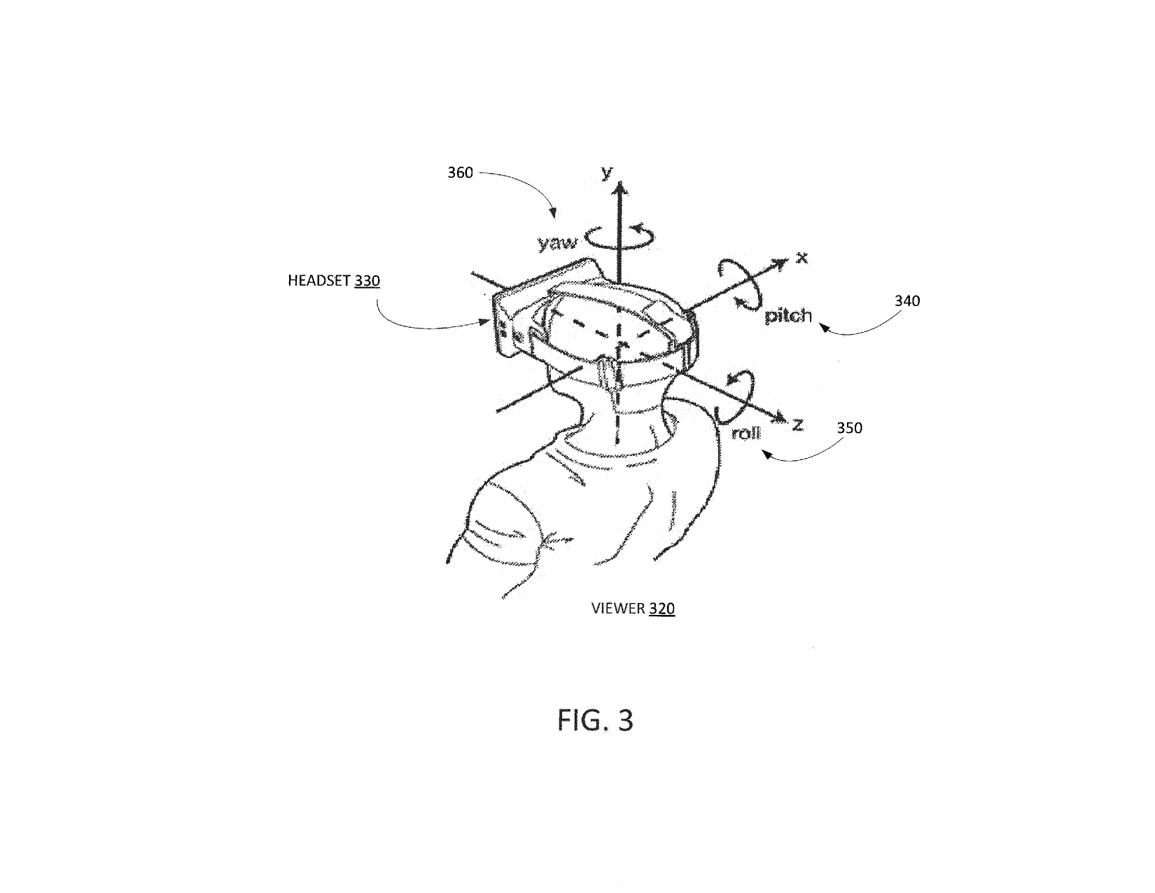

Referring to FIG. 3, a viewer 320 may wear a virtual reality headset 330 over the systems over the viewer 320. The viewer's 320 head may be considered at the center of a three-dimensional axis with axes of pitch 340, roll 350, and yaw 360. The pitch 340 may be considered the x-axis, the roll 350 may be considered the z-axis, and the yaw 360 may be considered the y-axis. The content displayed on the display may be modified based upon the orientation of the viewer and/or the movement of the viewer. The device, and especially in the case of a mobile device, may be selectively used to provide computing capabilities and provide a display, for the virtual reality headset. When not in use, the mobile device may be readily removed from the headset and used in a traditional manner.

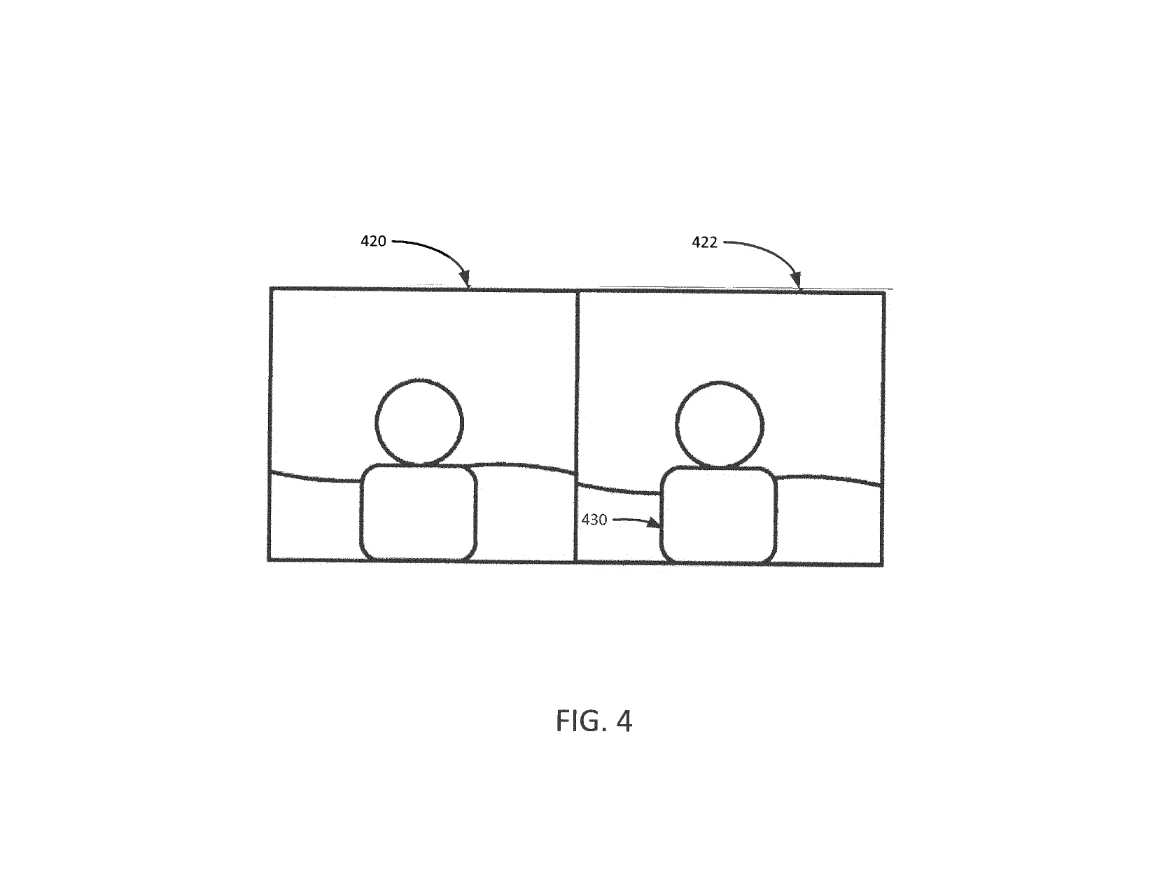

Referring to FIG. 4, a scene to be presented on a display 410 may be presented as a pair of images 420, 422. The two images 420 and 422 are shown, one for each eye and from slightly different perspectives, in order to create the perception of depth in the scene. For example, the individual 430 in the scene may be seen from slightly different angles in each image 420, 422. As a result, the mind of the viewer perceives the individual 430 having a depth of field which increase the immersion experience of the viewer. Typically, the headset holding the display includes a barrier so that each eye observes its respective image. The side by side presentation of the images permits the presentation of images at a substantially higher resolution than other techniques that include a distribution of the views along the length of the display.

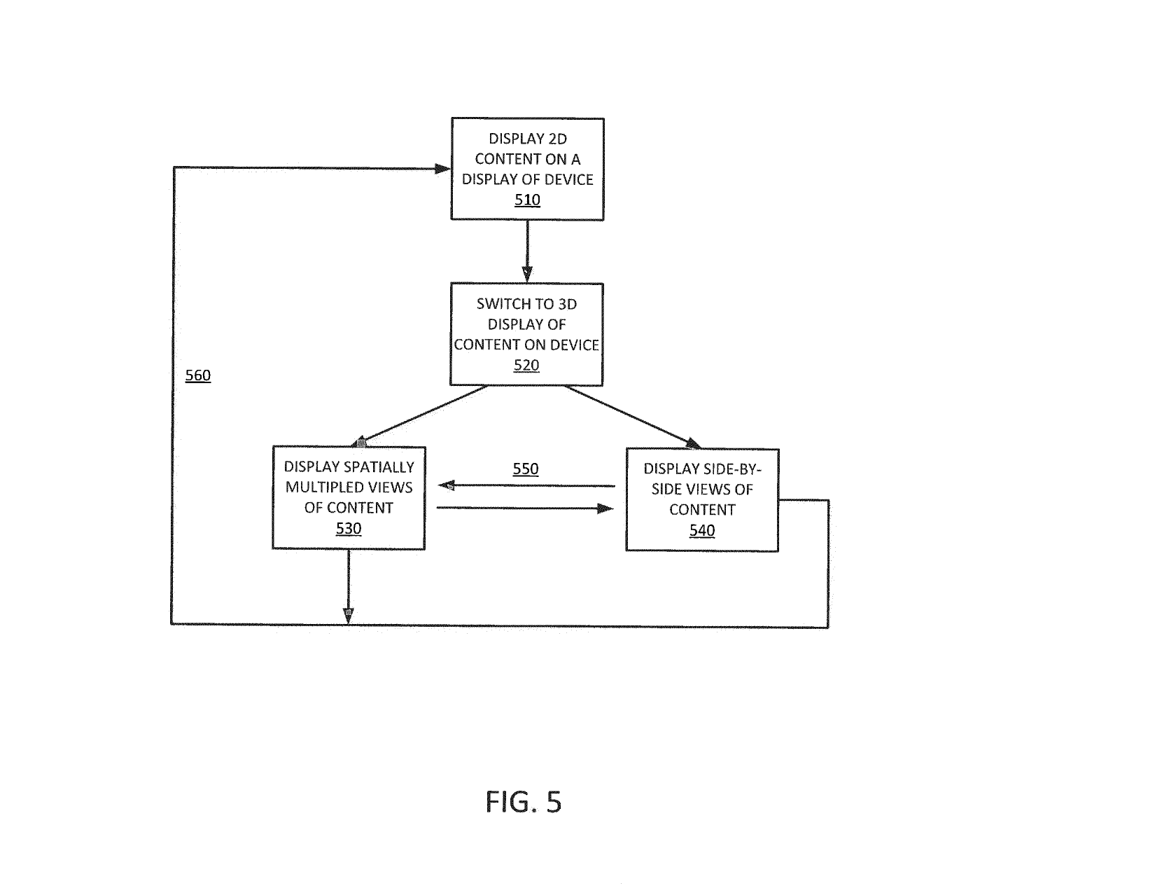

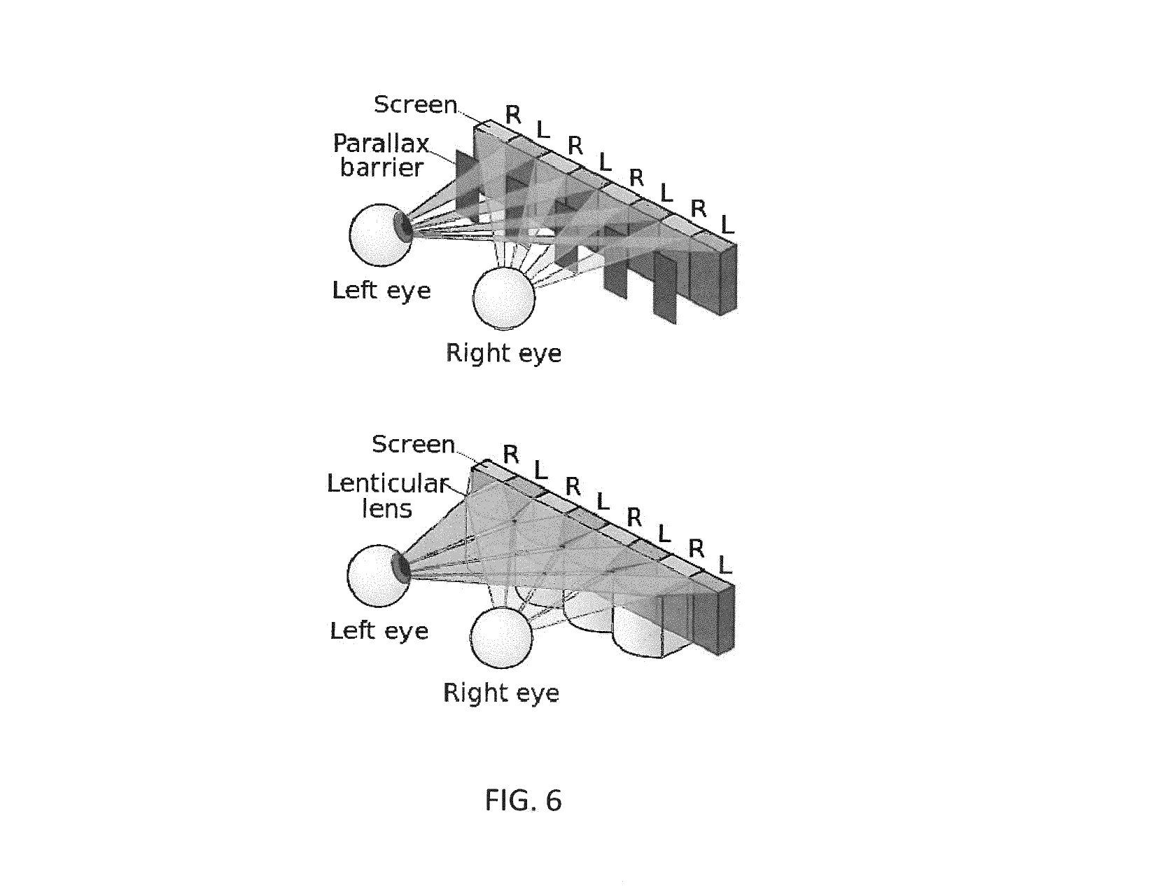

As illustrated in FIG. 5, it is desirable for the same device to be capable of displaying three dimensional content in a plurality of different manners, such as side-by-side views and autostereoscopic multi-view. By way of default, the device may display content in a traditional two dimensional manner 510. This is especially suitable for displaying text and photographs, and viewing the majority of Internet content. When it is desirable to display content in a three dimensional manner, the device may be switched 520 to render the content in a three dimensional manner. Depending on the environment in which the device is to be viewed by the viewer, the viewer may switch one of a plurality of different rendering techniques for the content. For example, when viewing the content in a hand-held open environment the viewer may switch to autostereoscopic multi- view 530. By of way of example, the autostereoscopic multi-view may be an autostereoscopic technique using a plurality of different views, using a parallax barrier or a lenticular lens, such as illustrated in FIG. 6. For example, when viewing the content using a head mounted display the viewer may switch to side- by-side views 540. By way of example, the side-by-side views may be a view for the left eye and a different view for the right eye, such as illustrated in FIG. 4.

The device may switch 550 between rendering content using different three dimensional viewing techniques. The device may also switch 560 from rendering content using one of the three dimensional viewing techniques to rendering content on the display using a two dimensional viewing technique.

For example, the switch may be a physical switch on the device. For example, the switch may be a virtual switch accessible to the viewer through an interface and/or a touch screen of the device. For example, the switch maybe a software switch accessible to the viewer through an interface and/or a touch screen of the device. For example, the switch may be accessible to other software programs to make the change. For example, the switch may be an automatic switch based upon the type of content to be displayed.

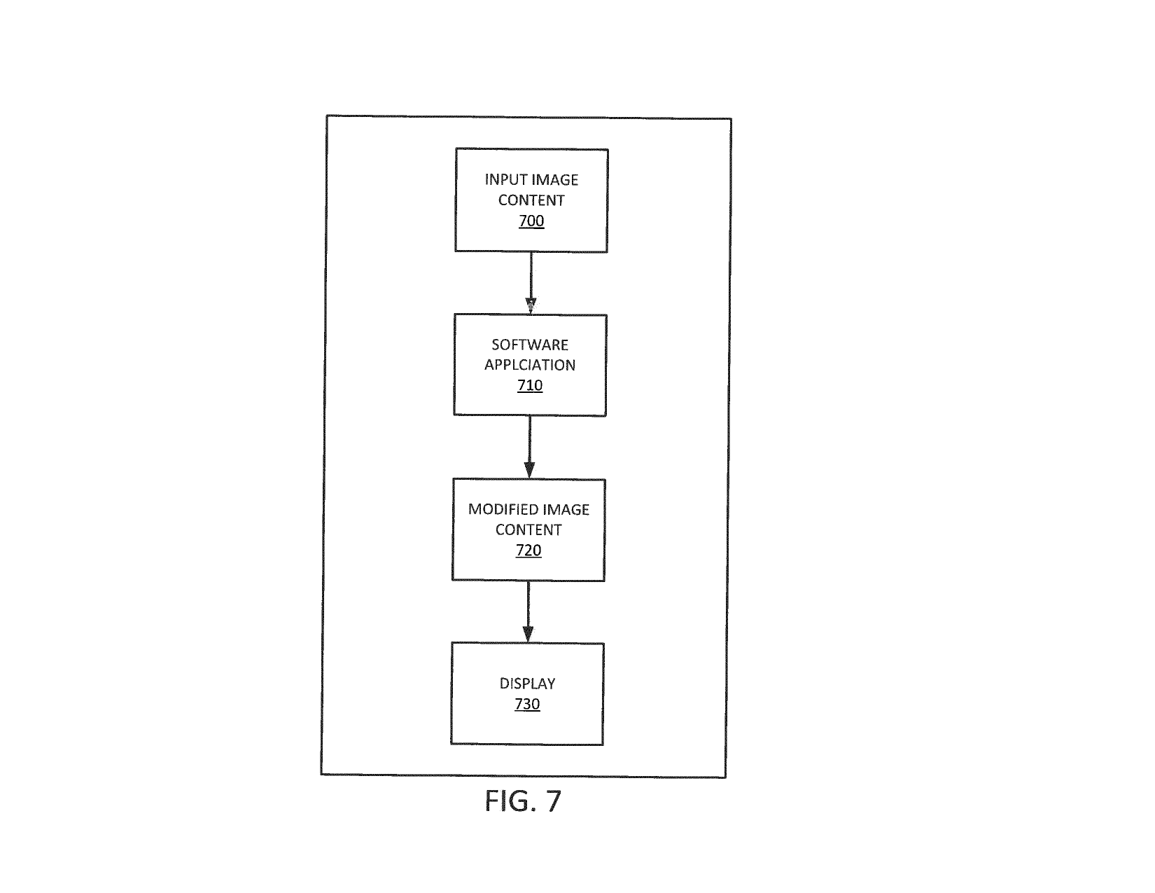

Typically the operating system associated with the display device provides two dimensional images to be displayed on the display. The two dimensional images typically are rendered on the entire display in a traditional manner, with the single scene being rendered across the display based upon the input image content. Referring to FIG. 7, however, it is desirable that the input image content 700 is modified by a hardware or by a software application 710 running on the device, which outputs modified image content 720. The modified image content extracts all or a portion of the input image content 700 to modified image content 720 that provides a side by side view for being displayed on the display 730. The device may be mounted in a head mounted display, and the side by side may be suitable for observing the scene as three dimensional image content.

In one embodiment, the device may have three different operational modes. A first mode may be a bypass mode where the input image content is in a three dimensional format and is rendered on the display in a manner that the image content is observed to be three dimensional images. For example, the input image content may be side by side or autostereoscopic. A second mode may be suitable for viewing two dimensional input image content on a headset by modifying the two dimensional input image content to a three dimensional format, such as side by side or autostereoscopic. A third mode may be suitable for two dimensional input image content that is modified by a software application to create stereoscopic two dimensional content. The stereoscopic two dimensional content may result in the entire image being observed as a two dimensional image, but appear to be at a further distance from the viewer, in a manner similar to that of a projector and screen.

Moreover, each functional block or various features used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or application-specific integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It is to be understood that the claims are not limited to the precise configuration and components illustrated above. Various modifications, changes and variations may be made in the arrangement, operation and details of the systems, methods, and apparatus described herein without departing from the scope of the claims.

I claim:

1. A visual system comprising:
(a) a display suitable for displaying video content thereon;
(b) a video stream being provided to said display suitable for being displayed video content thereon;
(c) a conversion module that receives said video content and generates a left eye image and a right eye image;
(d) a video processing module that renders said left eye image and said right eye image on said display, where said left eye image in combination with said right eye image form a stereoscopic view;
(d) selectively switching between displaying said left eye image and said right eye image on said display in a spatially overlapping manner across said display and a spatially non-overlapping manner across said display.

2. The system of claim 1 wherein said display is affixed to a mobile device.

3. The system of claim 1 wherein said display is interconnected to a non-mobile device.

4. The system of claim 1 wherein said video stream is provided to said video system from a remote location.

5. The system of claim 1 further comprising a video processing module that renders a left eye image and a right eye image on said display, where said left eye image in combination with said right eye image form a stereoscopic view.

6. The system of claim 1 wherein said left eye image is one of a plurality of left eye images based upon a viewer's location and said right eye image is one of a plurality of right eye images based upon said viewer's location.

7. The system of claim 1 wherein said left eye image and said right eye image are separated by an optical separator.

8. The system of claim 1 wherein said optical separator is a parallax barrier lens.

9. The system of claim 1 wherein said optical separator is a lenticular lens.

10. The system of claim 1 wherein a perceived depth between said right eye image and said left eye image is adjustable.

11. The system of claim 10 wherein said depth is user adjustable.

12. The system of claim 10 wherein said depth is automatically adjusted by said system based upon content of said right eye image and said left eye image.

13. The system of claim 1 wherein said left eye image and said right eye image are rendered on said display in a side by side manner.

14. The system of claim 1 wherein said spatially overlapping manner is an auto-stereoscopic multi-view manner.

15. The system of claim 1 wherein said spatially non-overlapping manner is a side by side manner.

16. The system of claim 1 wherein said selectively switching is based upon a user input.

17. The system of claim 1 wherein said selectively switching is based upon an environment of said display.

18. The system of claim 17 wherein said environment is a head- mounted display.

19. The system of claim 1 wherein said selectively switch further includes a two-dimensional viewing manner free from a stereoscopic view.
